(19) United States
(12) Patent Application Publication
(10) Pub. No.: US 2003/0109599 A1
(43) Pub. Date: Jun. 12, 2003

(54) UV cured UV blocking compositions and methods for making and using the same

(76) Inventor: Melvin E. Kamen, Highlands, NJ (US)

Correspondence Address: PENNIE AND EDMONDS, 1155 AVENUE OF THE AMERICAS, NEW YORK, NY, 100362711

(21) Appl. No.: 10/193,093

(22) Filed: Jul. 10, 2002

Related U.S. Application Data
(60) Provisional application No. 60/304,049, filed on Jul. 10, 2001.

(51) Int. Cl. C03C 17/00; C09D 5/00

(52) U.S. Cl. 523/160; 523/161

(57) ABSTRACT

The present invention is directed to compositions and methods relating to UV blocking inks for transparent substrates which requires UV curing for application onto the substrates.

### FIELD OF THE INVENTION

The invention is in the field of blocking Ultraviolet (UV) radiation with UV curable compositions. In particular, the invention relates to preventing UV transmission through glass and other transparent articles by applying one or more layers of a UV curable composition onto such articles, followed by curing such composition by exposure to UV radiation.

### BACKGROUND OF THE INVENTION

Ultraviolet radiation refers to invisible electromagnetic radiation between visible violet light and X rays. It ranges in wavelength from about 4 to about 400 nm and in frequency from about 10¹⁵ to 10¹⁷ Hz. It is a component of the sun's radiation and is also produced artificially in arc lamps, e.g., in the mercury arc lamp.

The UV radiation in sunlight is divided into three bands: UV-A (320-400 nanometers), UV-B (280-320 nanometers), and UV-C (below 280 nanometers). Much UV-B and most UV-C radiation is absorbed by the ozone layer of the atmosphere before it can reach the earth's surface.

Ultraviolet radiation from the sun is a significant cause of damage to cells and degradation in many materials. It is known that UV-A radiation can cause skin damage and may cause melanomatous skin cancer; and that UV-B radiation can cause sunburn and most common skin cancer; and that UV-C is the most potent and harmful form of UV radiation. It has also well-known that art, photographic works, and paper deteriorate when exposed for long periods to sunlight.

A number of technologies have been developed in order to screen out the UV radiation to minimize the damage and degradation caused by UV radiation. However, none of these methods is very satisfactory in terms of performance, cost, efficiency, and/or durability. Therefore, there remains a clear need for an improved method and composition for blocking transmission of UV radiation. Specifically, there is a need to develop an improved method and composition for blocking transmission of UV radiation through transparent substrates such as glass. More specifically, there is a need to develop an improved method and composition for blocking a substantial percentage of transmission of UV radiation over an extended period of time.

### SUMMARY OF THE INVENTION

The present invention is directed to UV blocking compositions suitable for transparent substrates, particularly glass, which when UV cured to the substrate are capable of blocking a significant amount of UV radiation. Thus, one object of the present invention is to provide a UV blocking composition by combining one or more UV blocking ingredients with one or more UV curable ingredients.

Another object of the present invention is to provide a method for reducing UV transmission through a transparent substrate such as glass by application of a UV blocking composition onto the substrate wherein the UV blocking composition is cured by UV radiation.

Yet another object of the present invention is to provide a glass or other transparent substrate which is capable of blocking a significant amount of UV radiation. Said glass or transparent substrate is coated with one or more UV cured UV blocking layers.

Yet still another object of the present invention to provide a process for making a glass or other transparent substrate capable of blocking a significant amount of UV radiation. Said glass or transparent substrate is made by coating (ink) with one or more UV cured UV blocking layers. Preferably the UV blocking compositions absorb more than 90% of UV transmission between 300-400 nm and more than about 97% of UV transmission between 300-385 nm.

### DESCRIPTION OF DRAWINGS

FIG. 1: UV transmission of Samples A, B, C and Comparison Sample.

FIG. 2: UV transmission of sample over various length of time.

### DETAILED DESCRIPTION

Unless otherwise specified, all % referred to weight% of the total UV curable, UV blocking coating composition (ink composition).

The invention is directed to compositions and methods for blocking the transmission of UV radiation through glass or other transparent substrates. More specifically, the present invention is directed to UV blocking compositions suitable for transparent substrates, particularly glass, which when UV cured to the substrate are capable of blocking a significant amount of UV radiation. Thus, one object of the present invention is to provide a UV blocking composition by combining one or more UV blocking ingredients with one or more UV curable ingredients.

Another object of the present invention is to provide a method for reducing UV transmission through a transparent substrate such as glass by application of a UV blocking composition onto the substrate wherein the UV blocking composition is cured by UV radiation.

Yet another object of the present invention is to provide a glass or other transparent substrate which is capable of blocking a significant amount of UV radiation. Said glass or transparent substrate is coated with one or more UV cured UV blocking layers.

Yet still another object of the present invention to provide a process for making a glass or other transparent substrate capable of blocking a significant amount of UV radiation. Said glass or transparent substrate is made by coating with one or more UV cured UV blocking layers. Preferably the UV blocking compositions absorb more than 90% of UV transmission between 300-400 nm and more than about 97% of UV transmission between 300-385 nm.

In one embodiment of the present invention, UV transmission is blocked by applying one or more layers of a coating composition comprising one or more UV blocking ingredients and one or more UV curable ingredients.

In a preferred embodiment, an adhesion promoter is applied between the transparent substrate and the one or more layers of UV blocking coating composition.

In another preferred embodiment, the coating composition comprises 2-(2′hydroxy-5′methacryloxyethylphenyl)-2H-benzotriazole (tradename: NORBLOC, made by Janssen Pharmaceutica, Titusville, N.J. 08560, USA).

In another preferred embodiment, the coating composition comprises bis (2,2,6,6-tetramethyl-1-(octyloxy)-4-piperidinyl) ester (tradename: TUNIVIN 123, made by Ciba-Geigy).

In another preferred embodiment, the coating composition comprises 2-(2H-benzotriazol-2-yl)-6-dodecyl-4-methyl-phenol (tradename: TINUVIN 171, made by Ciba-Geigy).

In another preferred embodiment, the coating composition comprises the UV-blocking ingredient(s) contained in TINUVIN 99, which is made by Ciba-Geigy.

In still another preferred embodiment, the coating composition comprises a combination of any of the above.

In a highly preferred embodiment, the coating composition comprises a 2-(2′hydroxy-5′methacryloxyethylphenyl)-2H-benzotriazole (NORBLOC), bis (2,2,6,6-tetramethyl-1-(octyloxy)-4-piperidinyl) ester (TINUVIN 123), 2-(2H-benzotriazol-2-yl)-6-dodecyl-4-methyl-phenol (TINUVIN 171), and TINUVIN 99.

In another embodiments, the invention includes transparent substrates coated with the above identified compositions as well as methods of making and using the UV curable compositions.

### UV Blocking Ingredients

UV blocking ingredients are commonly referred to as UV blockers. UV blockers are also referred to as UV absorbers or UV stabilizers. Any UV blocker(s) known or combination thereof can be used in the present invention. Examples of such UV blocker include, but are not limited to, Cyagard 1164L, Cyagard 3638, Cyagard UV 531, Cyagard UV 5411, Cyagard UV 9, Cyasorb 1084, Cyasorb 1164, Cyasorb 284, Cyasorb UV 1988, Cyasorb UV 2098, Cyasorb UV 2126, Cyasorb UV 24, Cyasorb UV 2908 (Cyasorb is a trademark owned by Cytec Technology Corp., 11 05 North Market St. Suite 1300, Wilmington, Del. 19801); Eastman Inhibitor RMB (Resorcinol Monobenzoate, available through Bio-Rad); Givsorb UV-1, Givsorb UV-2, Givsorb UV-13, Givsorb UV-14, Givsorb UV-15, Givsorb UV-16 (Givsorb is a trademark registerd to Givaudan Corporation, 100 Delawanna Avenue, Clifton, N.J., 07014); Mark 1535, Mark 446 (available through Bio-Rad), Maxgard 200, Maxgard 800 (Maxgard is a trademark registered to Garrison Industries, Inc., 135 Louis Hurley Road, El Dorado, Ak. 71731); Norbloc 6000, Norbloc 7966 (Norbloc is a trademark registered to Johnson & Johnson, One Johnson & Johnson Plaza New Brunswick N.J. 08933-7001); Quercetin; Sanduvor 3206, Sanduvor EPU, Sanduvor VSU (Sanduvor is a trademark registered to Sandoz Ltd., Lichtstrasse 35 Basle, Switzerland); Seesorb 201 (phenyl salicylate); Syntase 1200 (Neville-Synthese Organics, Inc., 2800 Neville Road, Pittsburgh Pa., 15225), THPE BZT, Tinuvin P (2-(2′-Hydroxy-5′-methylphenyl)benzotriazole 2-(2H-Benzotriazol-2-yl)-4-methylphenol 2-(2H-benzotriazol-2-yl)-p-cresol), Tinuvin 123, Tinuvin 171, Tinuvin 5055, Tinuvin 5151, Tinuvin 99-2, Tinuvin 144, Tinuvin 292, Tinuvin 384-2, Tinuvin 5050, Tinuvin 5060, Tinuvin 99, Tinuvin 109, Tinuvin 1130, Tinuvin 120, Tinuvin 1545, Tinuvin 1577FF, Tinuvin 320, Tinuvin 326, Tinuvin 327, Tinuvin 328, Tinuvin 384, Tinuvin 400, Tinuvin 400-2, Tinuvin 571, Tinuvin 840, Tinuvin 900, Tinuvin 928, Tinuvin P (Tinuvin is a trademark registered to Ciba-Geigy Corporation, 444 Saw Mill River Road, Ardsley, N.Y., 10502); Uvinul 3035, Uvinul 3039, Uvinul 3048, Uvinul 400, Uvinul D 49, Uvinul D 50, Uvinul P 25, Uvinul T-150 (Uvinul is trademark owned by BASF Corporation, 100 Cherry Hill Road Parsippany N.J. 07054).

Preferably, the UV blocker comprises Norbloc 7966 (chemical name: 2-(2′hydroxy-5′methacryloxyethylphenyl)-2H-benzotriazole (Janssen Pharmaceutica, Titusville, N.J. 08560, USA; a subsidiary of Johnson & Johnson).

Also preferably, the UV blocker comprises bis (2,2,6,6-tetramethyl-1-(octyloxy)-4-piperidinyl) ester (tradename: TINUVIN 123, made by Ciba-Geigy).

Also preferably, the UV blocker comprises 2-(2H-benzotriazol-2-yl)-6-dodecyl-4-methyl-phenol (tradename: TINUVIN 171, made by Ciba-Geigy).

Also preferably, the UV blocker comprises the UV-blocking ingredient(s) contained in TINUVIN 99, which is made by Ciba-Geigy.

More preferably, the UV blocker comprises a mixture of two or more components selected from Norbloc 7966, Tinuvin 123, Tinuvin 99, and Tinuvin 171.

Most preferably, the UV blocker comprising a mixture of Norbloc 7966, Tinuvin 123, Tinuvin 99, and Tinuvin 171.

The total weight percentages of the UV blocker(s) range from about 0.00001% to about 50%, preferably from about 0.1% to about 30%, more preferably from about 0.5% to about 20%, even more preferably from about 5% to about 15%, still more preferably from about 5% to about 12%, and most preferably about 10%.

The weight percentages of the each individual UV blocker(s) range from about 0.00001% to about 50%, preferably from about 0.1% to about 20%, more preferably from about 0.5% to about 15%, even more preferably from about 1% to about 10%, still more preferably from about 3% to about 8%, and most preferably from about 5%.

### UV Curable Components

The UV curable components used in the present invention may contain about 5-95%, preferably about 10-85%, more preferably about 15-75% of polymerizable reactants such as radiation curable monomers, oligomers, or low molecular weight homo- or copolymers, terpolymers, or graft or block copolymers which do not contain free acid groups. Examples of suitable monomers include epoxides, cycloaliphatic epoxides, vinyl chloride, styrene, ethyl acrylate, vinyl acetate, difunctional acrylic monomers such as hydroxy alkyl acrylates, or hydroxy alkyl methacrylates, vinyl butyrate, vinyl methyl ether, methyl methacrylate, isobornyl acrylate, acrylonitrile, or mixtures thereof. Suitable polymers include oligomers, homo- or copolymers, terpolymers, graft copolymers of the above monomers provided they have a molecular weight of less than about 50,000, otherwise it is too difficult to effect polymerization, i.e. curing. Preferred are acrylate homopolymers or acrylate or methacrylate copolymers, preferably acrylate or methacrylate copolymers. Examples of such acrylate or methacrylate copolymers include epoxy acrylates, copolymers of propylene glycol and a dicarboxylic acid, urethane acrylates, and the like. Preferably, the compositions contain one or more polymerizable reactants selected from the group consisting of urethane acrylate copolymers, tripropylene glycol acrylate, epoxy acrylate, and mixtures thereof.

Preferably, the radiation curable compositions of the invention contain about 5-95% by weight of acrylate or methacrylate monomers, or homo- or copolymers which do not contain acid functional groups.

### Pigment

The compositions used in the invention can optionally contain pigments. The amount of pigments can range from 1-95%, preferably 1-50%, more preferably 1-10% by weight of the total composition of pigment. A wide variety of pigments are suitable including organic and inorganic pigments. Examples of such pigments are set forth in U.S. Pat. No. 5,178,952 and U.S. Pat. No. 6,093,455, which are hereby incorporated by reference. Inorganic pigments include extender pigments such are baryites, barium sulfate, calcium carbonate, talc, clay, alumina, titanium dioxide,.white carbon, chinese white, zinc sulfide, lithopone, ultramarine, Prussian blue, cobalt, chrome oxide, viridian chrome green yellows, oranges, and reds, cadmium, chromium, iron oxides, carbon black, metallic pigments, aluminum powder, bronze powder, zinc chromate, strontium chromate, zinc dust, copper, and so on. Examples of suitable organic pigments include azo pigments, indolinones, isoindolinones, vat pigments, the Lakes, pthalocyanine pigments and so on. The preferred pigment to impart white color to the ink composition is titanium dioxide. Preferred red and yellow pigments are isoindolinones and pyrrolopyrrols as disclosed in U.S. Pat. Nos. 4,415,685; 4,579,949; 4,791,204; 4,666,455; 5,074,918; 4,783,540; 4,914,211; 4,585,878; as well as U.S. Pat. No. 5,571,359 of Kamen, et. al., all of which are hereby incorporated by reference. These pyrrolopyrrols are generally of the formula:

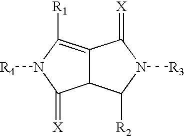

wherein R₁ and R₂ are each independently alkyl, arylalkyl, aryl, substituted or unsubstituted isocyclic or heterocyclic aromatic radicals; R₃ and R₄ are each independently H, substituted or unsubstituted alkyl, alkoxycarbonyl, aroyl (e.g. benzoyl), arylalkyl (e.g. benzyl), aryl (e.g. phenyl), alkanoyl, C₅₋₆ cycloalkyl, alkenyl, alkynyl, carbamoyl, alkylcarbamoyl, arylcarbamoyl, or alkoxycarbonyl; and X is O or S. Preferred is a compound wherein R₁ and R₂ are each independently phenyl or naphthyl, R₃ and R₄ are hydrogen, and X is O. Particularly preferred as a red pigment is pyrrolo 3,4-C pyrrol-1,4-dione, 2,5-dihydro-3,6-di-4-chlorophenyl which has a CAS number 84632-65-5 and is known by the common name C.I. pigment red 254. This pigment is commercially available from Ciba-Geigy Pigments Division, Newport, Del., under the tradename Irgazin DPP Red 80. Other Ciba-Geigy red pigments sold under the tradename Irgazin are also suitable.

Suitable isoindolinones are as set forth in U.S. Pat. Nos. 3,884,955, 3,867,404, 4,978,768, 4,400,507, 3,897,439 and 4,262,120 and 5,194,088 all of which are hereby incorporated by reference. Preferred isoindolinones are tetrachlorocyanobenzoic acid alkyl esters, particularly benzoic acid, 2,3,4,5-tetrachloro-6-cyano-methyl ester which is reacted with 2-methyl-1,3-benzenediamine and sodium methoxide. This pigment composition has the common name C.I. Pigment Yellow 109 and is available commercially from Ciba-Geigy Pigments Division, Newport Del. under the tradename Irgazin yellow 2GLTE. Other pigments in the Irgazin Yellow series as manufactured by Ciba-Geigy are also suitable.

Particularly suitable are blue pigments marketed by Ciba-Geigy under the tradename Irgazin Blue X-3367, or by Whittaker, Clark, & Daniels under the tradename Ultramarine Blue 5009.

Pigment(s) can be added for multiple purposes. It can added to provide color. It can also be added to mask undesirable color caused by other ingredients of the composition. For example, Norbloc 7966 has a yellowish color which is often undesirable. To blend or mask this yellowish color, a small amount of blue pigment is often added.

### Defoaming Agent

The ink compositions used in the invention also optionally contain about 0.01-10% of a defoaming agent, preferably a polyether-containing defoaming agent, which will cause the ink to apply smoothly on the glass substrate without bubbles or unevenness. A wide variety of defoamers are suitable, but preferred are defoamers sold by BYK Chemie under the BYK tradename. Examples of such defoaming agents are alkylvinyl ether polymers set forth in U.S. Pat. No. 5,187,201 and U.S. Pat. No. 6,093,455, which are hereby incorporated by reference. Examples of other defoamers include polyethers such as BYK-052, BYK-053, and BYK-033. BYK-052 and -053 are polyethers such as polyethylene or polypropylene glycol ethers, and in particular, polyvinyl ethers. Also suitable is BYK-354 which is a polyacrylate solution, and BYK-022 which is a mixture of hydrophobic solids and foam destroying polysiloxanes in polyglycol. Preferably the polyether defoaming agent is an alkoxylated alkyl phenol, more particularly a mixtures of petroleum distillates and an ethoxylated alkyl phenol, such as that sold by BYK-Chemie under the tradename BYK-033.

### Adhesion Promoter

The ink compositions used in the invention also preferably contain about 0.01-25%, preferably about 0.05-15%, more preferably about 0.1-5% of a silane adhesion promoter which will enhance adhesion of the cured resin to the glass surface. Details on composition and application of these adhesion promoter can be found in U.S. Pat. No. 6.093,455 and U.S. Pat. No.6,136,382. Examples of silanes are silane esters, vinyl silanes, methacryloxy silanes, epoxy silanes, sulfur silanes, amino silanes, or isocyanoto silanes. Suitable silanes include organofunctional silanes of the formula:

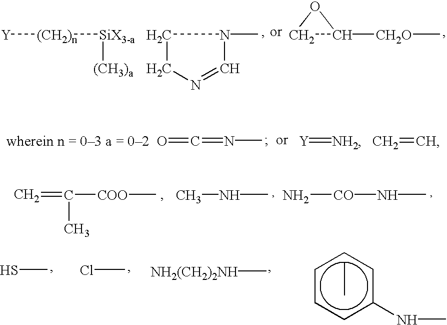

X is each independently CH₃, Cl, OCOCH₃, OC₂ H₄ OCH₃, (OC₂ H₄)₂ OCH₃, or ——OR, where R is a C₁₋₂₀ straight or branched chain alkyl, preferably methyl or ethyl.

Silanes having this formula are commercially available under the Dynasylan trademark from Huls, America, Inc., Piscataway, N.J. or Osi Specialities Inc. Other organofunctional silanes such as those disclosed in U.S. Pat. No. 5,221,560, U.S. Pat. No. 6,136,382 and U.S. Pat. No. 6,093,455, which are hereby incorporated by reference, are also suitable. Such organosilanes are acryloxyfunctional silanes including 3-methacryloxypropyltrimethoxysilane, 3-acryloxypropyltrimethoxysilane, 2-methacryloxyethyltrimethyoxysilane, 2-acryloxyethyltrimethyoxysilane, 3-methacryloxypropyltriethoxysilane, 3-acryloxypropyltrimethyoxysilane, 3-acryloxypropyltriethoxysilane, 2-methacryloxyethyltriethoxysilane, 2-methacryloxyethyltriethoxysilane, 2-acryloxyethyltriethoxysilane, etc. Suitable glycidoxy silanes include 3-glycidoxypropyltrimethoxysilane, 2-glycidoxyethyltrimethoxysilane, 3-glycidoxypropyltriethoxysilane, 2-glycidoxyethyltriethoxysilane, 3-glycidoxypropyltrimethyl silane, and so on. Preferred for use in the compositions of the invention are acryloxy-functional silanes, isocyanato silanes, and amino silanes. The preferred acryloxy-functional silane is 3-methacryloxypropyl trimethoxy silane, which is sold by Huls America, Inc. under the tradename DYNASYLAN MEMO. The preferred amino silane is sold by Huls America, Inc. under the tradename DYNASYLAN TRIAMO. The preferred isocyanoto silane is sold by Osi Specialities Inc., under the tradename A-1310. In the preferred ink compositions of the invention a mixture of the three silanes is preferred, generally 0.01-2% by weight of each.

The adhesion promoter can be applied in a various ways known. For example, the adhesion promoter applied to the transparent substrate before the UV curable composition is applied. Alternatively, the adhesion promoter can be mixed as part of the UV curable composition.

### Surfactant

The ink compositions also can optionally contain 0.01-20%, preferably 0.5-10%, more preferably 1-5% by weight of a fluorinated surfactant. The term “fluorinated surfactant” means a fluorine containing compound having at least one liphophilic group or portion and at least one hydrophilic group or portion. In particular, fluorocarbon or fluorosilicone surfactants are most desireable. Suitable surfactants include those set forth in U.S. Pat. No. 4,961,976 and U.S. Pat. No. 6,093,455 which are hereby incorporated by reference. Preferred are fluorocarbon surfactants, such as those marketed under the Fluorad trademark by 3M Company. These fluorochemical surfactants include fluorinated alkyl esters, fluorinated alkyl polyoxyethylene ethanols, and the like. Particularly preferred are nonionic fluorinated alkyl alkoxylates e.g. those marketed by 3M under the trademark FC-171. Preferred are fluroinated C₁₋₃₀ alkyl ethoxylates and propoxylates.

### Photoinitiator

The ink compositions preferably contain a photoinitiator which catalyzes the polymerization of the monomers upon exposure to the radiation by which the monomers are curable. There are generally two types of photoinitiators: free radical and cationic. Free radical initiators are more commonly used with ethylenically unsaturated monomers and oligomers, while cationic photoinitiators are used with epoxy or vinyl ether functional resins. Preferably, the compositions used in the invention contain free radical photoiniators. Suitable free radical-type photoiniators include carbonyl compounds such as ketones, acetophenones, benzophenones, and derivatives thereof. Examples of such materials include, for example, methyl ethyl ketone; benzophenone; benzyl dimethyl ketal;

1-hydroxycyclohexylphenylketone; diethyoxyacetophenone;

2-methyl-1-(methylethiophenyl)-2-(4-morpholinyl)-1-propanone;

2-benzyl-2-N,N-dimethylamino-1,4(4-morpholinophenyl)-1-butanone;

2,2-dimethoxy-2-phenyl acetophenone;

2-methyl-1-[4-(methylthio)phenyl]-2-morpholino propan-1-one;

2-hydroxy-2-methyl-1-phenyl-propan-1-one;

4-(2-hydroxyethoxy)phenyl-(2-hydroxy-2-methylpropyl)ketone; and a mixture of bis(2,6-dimethyoxybenzoyl)-2-4-4-trimethylpentyl phosphine oxide and 2-hydroxy-2-methyl-1-phenyl-propan-1-one. Preferred is a mixture of 25% bis(2,6-dimethyoxybenzoyl)-2-4-4-trimethylpentyl phosphine oxide and 75% 2-hydroxy-2-methyl-1-phenyl-propan-1-one, which is sold under the tradename Irgacure 1700 by Ciba-Geigy.

Small amounts of cationically curable monomers or oligomers may be used in the compositions of the invention, for example less than about 10%, preferably less than about 5% by weight of the ink composition. Various types of cationic photoinitiators are suitable. Both ionic cationic photoinitiators such as onium salts or organometallic salts are suitable as well as non-ionic cationic photoinitiators such as organosilanes, latent sulphonic acids and the like. Preferred are photosensitive onium salts, in particular, onium salts such as those disclosed in U.S. Pat. Nos. 4,058,401, 4,138,255, 4,161,478, 4,175,972, all of which are hereby incorporated by reference. Triaryl sulphonium salts are most preferred, in particular triaryl sulphonium salts such as those sold by Union Carbide under the tradename Cyracure UVI 6990 and 6974. Also suitable are ferrocenium salts such as those sold under the Irgacure tradename by Ciba-Geigy, in particular Irgacure 261. Sulphonyloxy ketones and silyl benzyl ethers are also good cationic photoinitiators. A detailed analysis of the mechanism of cationic curing is disclosed in “Photosensitized Epoxides as a Basis for Light-Curable Coatings” by William R. Watt, American Chemical Society Symposium, Ser. 114, Epoxy Resin Chemistry, Chapter 2, 1979, and in “Chemistry and Technology of UV and EB Formulation for Coatings, Inks, and Paints,” Volume 3, entitled “Photoinitiators for Free Radical and Cationic Polymerization, K. K. Dietliker, pages 332-374 (1991), both of which are hereby incorporated by reference.

Photosensitive onium salts are used as photoinitators in cationic curing, in particular, onium salts such as those disclosed in U.S. Pat. Nos. 4,058,401, 4,138,255, 4,161,478, 4,175,972, all of which are hereby incorporated by reference. Triaryl sulphonium salts are most preferred, in particular triaryl sulphonium salts such as those sold by Union Carbide under the tradename Cyracure UVI 6990 and 6974. The photoiniator is generally present at about 0.1-15%, preferably about 0.5-12%, more preferably about 0.5-10% by weight of the total composition.

### Substrates

Any transparent material can be used as the substrate for the coating. Non-limiting examples include glass and polycarbonate.

In a preferred embodiment, the substrate is glass. All types of glass can be used for this invention. Suitable glass can be a wide variety of densities and optical characteristic.

Non-limiting examples of glass include architectural glass, acoustical glass, temper-resistent glass, clear glass, or tinted glass, display glass and insulating glass.

The substrate can be any size and shape.

### Application of Coating and Property of Coating

The UV curable, UV blocking coating composition can be applied in any methods known.

As non-limiting examples, the coating composition can be applied by silk screening or rolling on.

In a preferred embodiment, an adhesion promoter is applied onto the substrate prior to the application of the coating composition. Adhesion promoter is discussed in detail above.

The coating can be of various thickness. The thickness of the coating ranges from about 0.5 micron to about 50 micron. In a preferred embodiment, the coating thickness is from about 2 to about 30 micron. In a more preferred embodiment, the coating thickness is from about 5 to about 20 micron. In a still more preferred embodiment, the thickness is from about 9 to about 20 micron. In a most preferred embodiment, the thickness is about 15 micron.

When a mesh screen is used to apply the coating, the thickness of the coating depends on the mesh size. For example, a sample prepared by using 255 mesh screen is about 15 micron, whereas a sample prepared by using 390 mesh screen is about 10 microns thick.

Generally speaking, the thicker the coating layer, the better UV blockage. However, as the thickness increases, the cost of coating increases. Furthermore, some UV blocking ingredients such as Norbloc 7966 has a yellowish color, so as the thickness of the coating increases, the coating would be more yellowish which may not be desirable.

### Curing the UV Blocking Coating

The UV blocking coating can be cured using any methods known. One of skill in the art would know how to adjust the time, speed, intensity, temperature, wavelength, and various other factors to obtain desirable curing.

In a preferred embodiment, the wavelength of the UV radiation for curing ranges from about 300 nm to about 415 nm. In a more preferred embodiment, the wavelength ranges from about 350 to 415 nm. In a even more preferred embodiment, about 390 to 410 nm. In a most preferred embodiment 390 to 400 nm.

In a preferred embodiment, the UV curing lamp is about 600 W, and the curing speed is about 200 ft/min.

Various publications are cited herein, the disclosures of which are incorporated by reference in their entirety for all purposes.

Having described the invention, the following examples are included to illustrate the benefits of the present invention. The examples are only illustrative and are not meant to unduly limit the scope of the present invention.

### EXAMPLES

### Example 1

A UV blocking coating composition of the present invention is prepared with the following ingredients

| Ingredient | Weight (gram) |
|---|---|
| SR399 | 18.272 |
| CN104 | 4.568 |
| Eb5129 | 6.395 |
| SR238 | 6.395 |
| Tinuvin 123 | 0.457 |
| Norbloc 7966 | 0.914 |
| Tinuvin 99 | 3.0 |
| Tinuvin 171 | 1.0 |
| Solution of CAB 531-1 | 3.0 |
| HS 40 | 0.4 |
| D-62 | 1.0 |
| D-604 | 0.25 |
| Rad 2250 | 1.0 |
| I-500 | 0.3 |
| I-184 | 0.5 |
| D-1173 | 0.7 |
| I-1700 | 1.0 |
| CN384 | 0.85 |
| FC 171 | 0.25 |
| TOTAL | 50.3 |

SR399 is Dipentaerythritol pentaacrylate, available from Sartomer Company, Inc. CN104 is Epoxy acrylate available from Sartomer Company, Inc. Eb5129 is urethane diacrylate available from UCB Chemical. SR238 is 1,6-Hexanediol Diacrylate available from Sartomer Company, Inc. Norbloc 7966 is 2-(2′hydroxy-5′methacryloxyethylphenyl)-2H-benzotriazole, available from Janssen Pharmaceutica. Tinuvin 123 is decanedioic acid, bis (2,2,6,6,-tetra methyl-4-piperidinyl) ester reaction products with 1,1-dimethyl ethyl hydroperxoide and octane made by Ciba-Geigy. Tinuvin 99 is 3(2H-Benzotriazole-2-yl) 5-(1,1-dimethyl ethyl)-4-hydroxybenzenepropanoic acid, C7-9-branched alkyl esters. Tinuvin 171 is 2(2H-Benzotrizaol-2-yl)-6-(dodecyl)-4-methylphenol, branched and liner, made by Ciba-Geigy. HS 40 is an additive made by Air Products and Chemicals. D-62 is a defoamer made by Air Products and Chemicals. D-604 a surfactant made by Air Products and Chemicals. FC171 is a flurochemcial surfactant made by 3M. CN384 is acrylated amine acrylic ester made by Sartomer. Solution if CAB 531-1 is a 20% CAB 531-1 (Cellulose Acetate Butyrate) and 80% SR285 (Sartomer). I-1700 is a mixture of 25% by weight bis(2,6-dimethoxybenzoyl)-2,4-,4-trimethylpentyl phosphine oxide and 75% by weight 2hydroxy-2-methyl-1-phenyl-propan-1-one. I-500 is 1-hydroxyacryciohexyl pentyl ketone made by Ciba-Geigy. I-184 is 1-hydroxy cyclohexyl pentyl ketone by Ciba-Geigy. D-173 is oxy-2-methyl-1-phenyl-1 propanone.

This coating composition contains about 1.8% Norbloc 7966, about 0.9% Tinuvin 123, about 6% Tinuvin 99 and about 2% Tinuvin 171. The total percentage of UV blocking ingredients is about 10.7%.

### Example 2

The coating composition detailed in Example 1 was applied onto glass substrates by screening. Prior to the application of the coating, the glass substrate were sprayed with a solution of adhesion promoter comprising silane. Three different mesh size were used for the application of the coating composition resulting three coated glass samples of different coating thickness.

| | | Thickness of coating |
|---|---|---|
| Sample | Mesh Screen Size | (micron) |
| A | 255 | 15 |
| B | 390 | 11 |
| C | 508 | 9 |

### Example 3

The UV transmission of coated glass samples A-C described in Example 2 were measured from wave length 275 nm to 425 nm. The numerical results are attached herewith in Exhibit A.

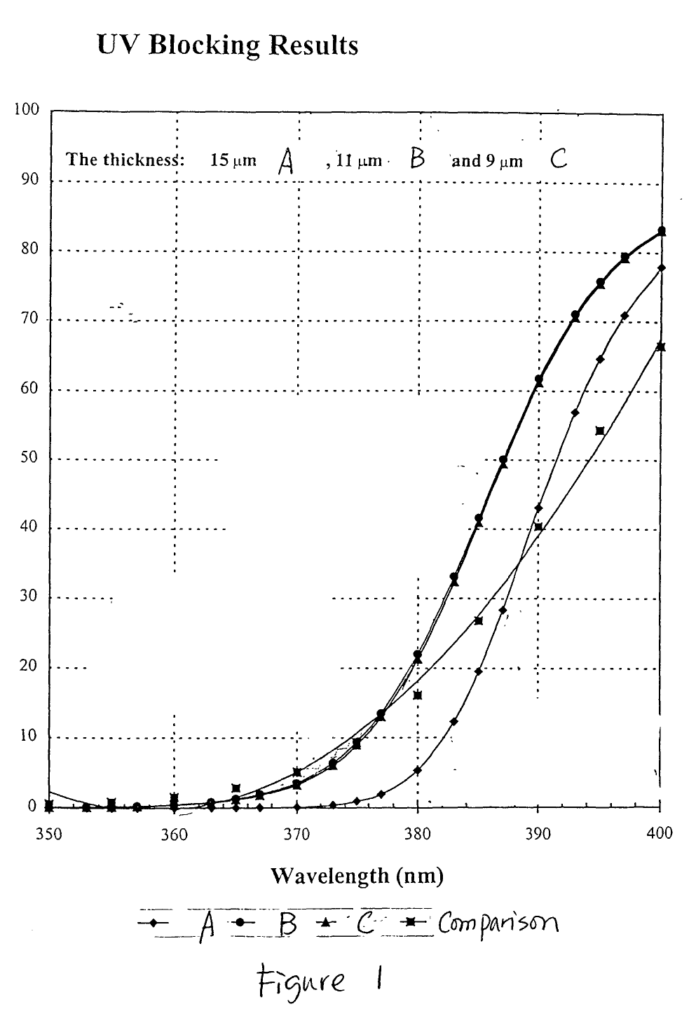

The transmission/absorption spectrum of each of these samples were also plotted as FIG. 1 (Sample A: ♦; Sample B: ●; Sample C: ▴). For comparison, a commercially available sample (▪) is also plotted in the same figure. The result indicates that Sample A has much better UV blocking performance than the commercially available product up to the wavelength of about 388 nm.

### Example4

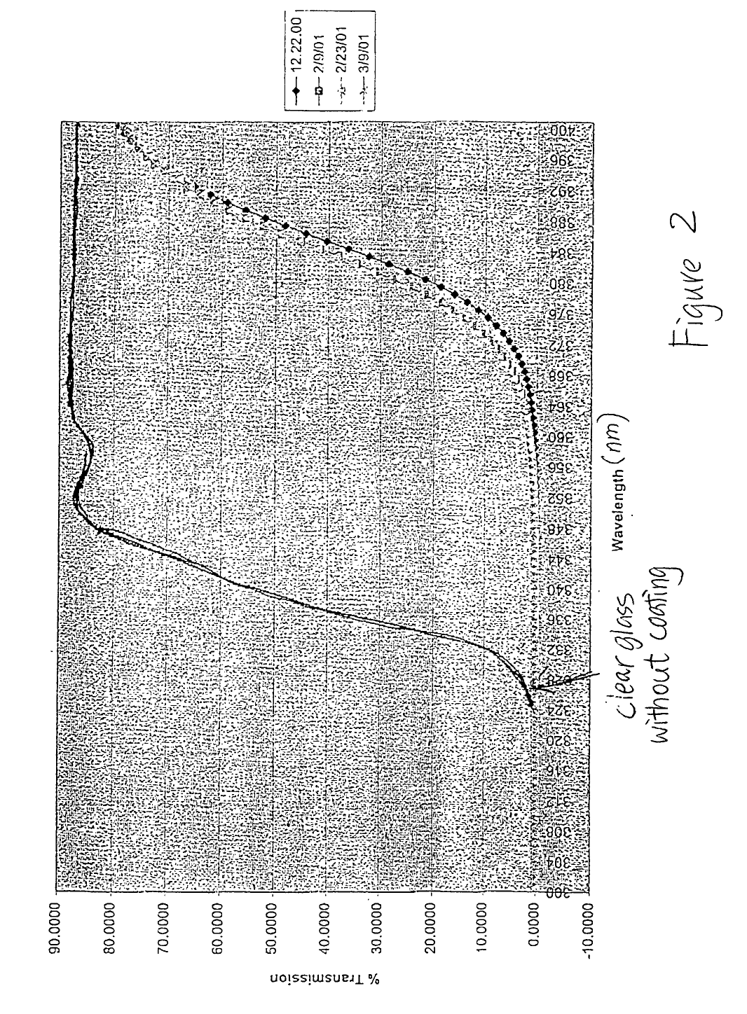

To demonstrate that the UV blocking ability of the composition of the present invention is long-lasting, UV transmission of the Sample B was measured at different times, earliest at Dec. 22, 2000, followed by Feb. 9, 2001, Feb. 23, 2001, and Mar. 9, 2001. The results are plotted in FIG. 2. The result indicates that the UV blocking capability remained relatively constant over an extended period of time. The UV transmission of clear glass without any coating is also plotted in FIG. 2 for comparison.

### Example 5

Another UV blocking coating composition of the present invention is prepared with he following ingredients.

| Ingredient | Weight (gram) |
|---|---|
| SR399 | 36 |
| CN104 | 10 |
| Eb5129 | 10 |
| SR238 | 15 |
| Tinuvin 123 | 1.2 |
| Norbloc 7966 | 3.6 |
| Tinuvin 99 | 6.6 |
| Tinuvin 171 | 2.42 |
| Solution of CAB 531-1 | 6.0 |
| HS 40 | 0.8 |
| D-62 | 1.6 |
| D-604 | 0.4 |
| I-500 | 0.7 |
| I-184 | 1.0 |
| D-1173 | 1.4 |
| I-1700 | 2.0 |
| CN384 | 1.7 |
| FC 171 | 0.4 |
| TOTAL | 100.82 |

This coating composition contains about 3.6% Norbloc 7966, about 1.2% Tinuvin 123, about 6.6% Tinuvin 99 and about 2.4% Tinuvin 171. The total percentage of UV blocking ingredients is about 13.8%.

| A | | | B | | C | |
|---|---|---|---|---|---|---|
| 275 | 0.037 | | 275 | 0.017 | 275 | 0.001 |
| 276 | 0.021 | | 276 | 0.016 | 276 | 0.002 |
| 277 | 0 | | 277 | 0.015 | 277 | −0.001 |
| 278 | 0.009 | | 278 | 0.02 | 278 | 0.006 |
| 279 | 0.016 | | 279 | 0.01 | 279 | 0.004 |
| 280 | 0.046 | | 280 | −0.007 | 280 | 0.009 |
| 281 | 0.003 | | 281 | 0.02 | 281 | 0.005 |
| 282 | −0.005 | | 282 | 0.03 | 282 | 0.001 |
| 283 | −0.005 | | 283 | 0.029 | 283 | 0.022 |
| 284 | −0.031 | | 284 | 0.038 | 284 | −0.006 |
| 285 | 0.018 | | 285 | 0.032 | 285 | 0.011 |
| 286 | 0.016 | | 286 | 0.032 | 286 | 0.012 |
| 287 | 0.008 | | 287 | 0.034 | 287 | 0.005 |
| 288 | 0.026 | | 288 | 0.026 | 288 | −0.011 |
| 289 | 0.018 | | 289 | 0.035 | 289 | −0.014 |
| 290 | −0.003 | | 290 | 0.031 | 290 | −0.008 |
| 291 | −0.002 | | 291 | 0.021 | 291 | −0.017 |
| 292 | 0.004 | | 292 | 0.016 | 292 | 0.024 |
| 293 | 0.027 | | 293 | 0.013 | 293 | −0.021 |
| 294 | 0.055 | | 294 | −0.005 | 294 | 0.047 |
| 295 | 0.013 | | 295 | 0.01 | 295 | −0.023 |
| 296 | 0.053 | | 296 | 0.025 | 296 | −0.003 |
| 297 | 0.023 | | 297 | 0.039 | 297 | −0.007 |
| 298 | 0.011 | | 298 | 0.007 | 298 | −0.018 |
| 299 | 0.018 | | 299 | 0.035 | 299 | −0.02 |
| 300 | 0.007 | | 300 | 0.013 | 300 | 0.005 |
| 301 | −0.006 | | 301 | 0.02 | 301 | −0.017 |
| 302 | 0.014 | | 302 | 0.042 | 302 | 0 |
| 303 | −0.007 | | 303 | −0.008 | 303 | −0.011 |
| 304 | −0.004 | | 304 | 0.03 | 304 | 0.004 |
| 305 | −0.041 | | 305 | 0.047 | 305 | 0.037 |
| 306 | 0.02 | | 306 | −0.004 | 306 | 0.023 |
| 307 | 0.02 | | 307 | −0.007 | 307 | −0.012 |
| 308 | −0.011 | | 308 | 0.025 | 308 | −0.015 |
| 309 | 0.005 | | 309 | 0.006 | 309 | −0.03 |
| 310 | 0.009 | | 310 | 0.033 | 310 | 0 |
| 311 | 0.046 | | 311 | 0.03 | 311 | 0.007 |
| 312 | −0.016 | | 312 | 0.025 | 312 | −0.01 |
| 313 | 0.017 | | 313 | 0.042 | 313 | −0.038 |
| 314 | 0.028 | | 314 | 0.04 | 314 | 0.006 |
| 315 | 0.037 | | 315 | 0.045 | 315 | −0.009 |
| 316 | 0.055 | | 316 | 0.049 | 316 | −0.017 |
| 317 | −0.006 | | 317 | 0.049 | 317 | 0.008 |
| 318 | 0.045 | | 318 | 0.082 | 318 | 0.079 |
| 319 | 0.022 | | 319 | 0.038 | 319 | −0.012 |
| 320 | 0.018 | | 320 | 0.056 | 320 | 0.015 |
| 321 | 0.04 | | 321 | 0.071 | 321 | 0.003 |
| 322 | 0.062 | | 322 | 0.055 | 322 | 0.019 |
| 323 | 0.047 | | 323 | 0.104 | 323 | 0.019 |
| 324 | 0.044 | | 324 | 0.072 | 324 | 0.033 |
| 325 | 0.012 | | 325 | 0.104 | 325 | 0.051 |
| 326 | 0.019 | | 326 | 0.071 | 326 | 0.019 |
| 327 | 0.092 | | 327 | 0.071 | 327 | 0.038 |
| 328 | −0.004 | | 328 | 0.065 | 328 | 0.03 |
| 329 | −0.003 | | 329 | 0.083 | 329 | 0.054 |
| 330 | −0.004 | | 330 | 0.076 | 330 | 0.025 |
| 331 | 0.016 | | 331 | 0.06 | 331 | 0.035 |
| 332 | 0.01 | | 332 | 0.071 | 332 | 0.037 |
| 333 | 0.008 | | 333 | 0.074 | 333 | 0.038 |
| 334 | 0.015 | | 334 | 0.074 | 334 | 0.043 |
| 335 | 0.008 | | 335 | 0.06 | 335 | 0.028 |
| 336 | 0.011 | | 336 | 0.049 | 336 | 0.024 |
| 337 | 0.003 | | 337 | 0.065 | 337 | 0.034 |
| 338 | 0.006 | | 338 | 0.067 | 338 | 0.044 |
| 339 | 0.006 | | 339 | 0.055 | 339 | 0.036 |
| 340 | 0.01 | | 340 | 0.051 | 340 | 0.055 |
| 341 | −0.003 | | 341 | 0.058 | 341 | 0.047 |
| 342 | 0.003 | | 342 | 0.069 | 342 | 0.037 |
| 343 | 0.013 | | 343 | 0.067 | 343 | 0.048 |
| 344 | 0.009 | | 344 | 0.069 | 344 | 0.054 |
| 345 | 0.014 | | 345 | 0.071 | 345 | 0.067 |
| 346 | 0.002 | | 346 | 0.068 | 346 | 0.065 |
| 347 | 0.003 | | 347 | 0.088 | 347 | 0.058 |
| 348 | 0.011 | | 348 | 0.095 | 348 | 0.067 |
| 349 | −0.001 | | 349 | 0.095 | 349 | 0.066 |
| 350 | 0.002 | | 350 | 0.118 | 350 | 0.071 |
| 351 | −0.002 | | 351 | 0.125 | 351 | 0.095 |
| 352 | 0.016 | | 352 | 0.136 | 352 | 0.117 |
| 353 | 0.013 | | 353 | 0.175 | 353 | 0.12 |
| 354 | 0.013 | | 354 | 0.199 | 354 | 0.152 |
| 355 | 0.006 | | 355 | 0.23 | 355 | 0.173 |
| 356 | 0.012 | | 356 | 0.262 | 356 | 0.212 |
| 357 | 0.011 | | 357 | 0.299 | 357 | 0.249 |
| 358 | 0.009 | | 358 | 0.352 | 358 | 0.307 |
| 359 | 0.008 | | 359 | 0.428 | 359 | 0.366 |
| 360 | 0.018 | | 360 | 0.5 | 360 | 0.425 |
| 361 | 0.008 | | 361 | 0.603 | 361 | 0.52 |
| 362 | 0.007 | | 362 | 0.729 | 362 | 0.613 |
| 363 | 0.027 | | 363 | 0.873 | 363 | 0.769 |
| 364 | 0.012 | | 364 | 1.064 | 364 | 0.959 |
| 365 | 0.02 | | 365 | 1.286 | 365 | 1.164 |
| 366 | 0.025 | | 366 | 1.572 | 366 | 1.422 |
| 367 | 0.046 | | 367 | 1.929 | 367 | 1.769 |
| 368 | 0.057 | | 368 | 2.358 | 368 | 2.155 |
| 369 | 0.089 | | 369 | 2.883 | 369 | 2.666 |
| 370 | 0.125 | | 370 | 3.53 | 370 | 3.268 |
| 371 | 0 19 | | 371 | 4.339 | 371 | 4.052 |
| 372 | 0.283 | | 372 | 5.271 | 372 | 4.922 |
| 373 | 0.406 | | 373 | 6.443 | 373 | 6.054 |
| 374 | 0 626 | | 374 | 7.811 | 374 | 7.367 |
| 375 | 0.932 | | 375 | 9.425 | 375 | 8.96 |
| 376 | 1.354 | | 376 | 11.321 | 376 | 10.791 |
| 377 | 1.946 | | 377 | 13.511 | 377 | 12.967 |
| 378 | 2.779 | | 378 | 16.068 | 378 | 15.451 |
| 379 | 3.874 | | 379 | 18.848 | 379 | 18.224 |
| 380 | 5.319 | 0.233728 | 380 | 22.008 | 380 | 21.307 |
| 381 | 7.179 | | 381 | 25.471 | 381 | 24.759 |
| 382 | 9.51 | | 382 | 29.244 | 382 | 28.503 |
| 383 | 12.306 | | 383 | 33.131 | 383 | 32.374 |
| 384 | 15.691 | | 384 | 37.282 | 384 | 36.563 |
| 385 | 19.568 | | 385 | 41.636 | 385 | 40.912 |
| 386 | 23.842 | | 386 | 45.943 | 386 | 45.242 |
| 387 | 28.377 | | 387 | 50.092 | 387 | 49.421 |
| 388 | 33.207 | | 388 | 54.202 | 388 | 53.549 |
| 389 | 38.16 | | 389 | 58.11 | 389 | 57.489 |
| 390 | 43.043 | | 390 | 61.721 | 390 | 61.138 |
| 391 | 47.882 | | 391 | 65.109 | 391 | 64.579 |
| 392 | 52.521 | | 392 | 68.212 | 392 | 67.717 |
| 393 | 56.94 | | 393 | 71.055 | 393 | 70.57 |
| 394 | 60.91 | | 394 | 73.517 | 394 | 73.094 |
| 395 | 64.638 | | 395 | 75.767 | 395 | 75.39 |
| 396 | 67.929 | | 396 | 77.718 | 396 | 77.376 |
| 397 | 70.938 | | 397 | 79.456 | 397 | 79.139 |
| 398 | 73.53 | | 398 | 80.915 | 398 | 80.615 |
| 399 | 75.886 | | 399 | 82.246 | 399 | 81.986 |
| 400 | 77.901 | 8.899901 | 400 | 83.36 | 400 | 83.124 |
| 401 | 79.605 | | 401 | 84.239 | 401 | 84.079 |
| 402 | 81.138 | | 402 | 85.1 | 402 | 84.926 |
| 403 | 82.372 | | 403 | 85.75 | 403 | 85.57 |
| 404 | 83.46 | | 404 | 86.319 | 404 | 86.171 |
| 405 | 84.354 | | 405 | 86.818 | 405 | 86.653 |
| 406 | 85.141 | | 406 | 87.219 | 406 | 87.11 |
| 407 | 85.758 | | 407 | 87.545 | 407 | 87.437 |
| 408 | 86.317 | | 408 | 87.831 | 408 | 87.736 |
| 409 | 86.781 | | 409 | 88.055 | 409 | 87.961 |
| 410 | 87.14 | | 410 | 88.245 | 410 | 88.168 |
| 411 | 87.462 | | 411 | 88.416 | 411 | 88.315 |
| 412 | 87.722 | | 412 | 88.542 | 412 | 88.469 |
| 413 | 87.944 | | 413 | 88.63 | 413 | 88.583 |
| 414 | 88.167 | | 414 | 88.791 | 414 | 88.718 |
| 415 | 88.325 | | 415 | 88.845 | 415 | 88.773 |
| 416 | 88.457 | | 416 | 88.941 | 416 | 88.87 |
| 417 | 88.6 | | 417 | 89.039 | 417 | 89 |
| 418 | 88.724 | | 418 | 89.088 | 418 | 89.037 |
| 419 | 88.86 | | 419 | 89.181 | 419 | 89.137 |
| 420 | 88.911 | | 420 | 89.222 | 420 | 89.161 |
| 421 | 89.021 | | 421 | 89.237 | 421 | 89.2 |
| 422 | 89.08 | | 422 | 89.299 | 422 | 89.269 |
| 423 | 89.127 | | 423 | 89.299 | 423 | 89.252 |
| 424 | 89.216 | | 424 | 89.408 | 424 | 89.351 |
| 425 | 89.285 | | 425 | 89.421 | 425 | 89.391 |

What claimed is:

1. An ultraviolet (UV) blocking ink comprising at least one UV blocking agent and at least one UV curable component.

2. The composition of claim 1 further comprising at least one photo initiator.

3. The composition of claim 1 further comprising at least one silane.

4. The composition of claim 1 further comprising at least one pigment.

5. The composition of claim 1 further comprising at least one defoaming agent.

6. The composition of claim 1 further comprising at least one surfactant.

7. The composition of claim 1 wherein the UV blocking agent(s) is present in an amount of about 5 wt % to 15 wt %.

8. An ultraviolet (UV) blocking ink comprising about 1 to 5% Norbloc (2-(2′hydroxy-5′methacryloxyethylphenyl)-2H-benzotriazole) , about 0.5 to 1.5% Tinuvin 123 ( bis (2,2,6,6-tetramethyl-1-(octyloxy)-4-piperidinyl) ester), about 3 to 9% Tinuvin 99 (3(2H-Benzotriazole-2-yl) 5-(1,1-dimethyl ethyl) -4-hydroxybenzenepropanoic acid, C7-9-branched alkyl esters), 1 to 3% Tinuvin 171 (2-(2H-benzotriazol-2-yl)-6-dodecyl-4-methyl-phenol).

9. An ultraviolet (UV) blocking ink comprising about 30-40% SR399 (Dipentaerythritol pentaacrylate), about 6-10% CN 104 (Epoxy acrylate), about 10-15% Eb5129 (urethane diacrylate), about 10-15% SR238 (urethane diacrylate), about 0.5-1.2% Tinuvin 123 (decanedioic acid, bis (2,2,6,6,-tetra methyl -4-piperidinyl) ester reaction products with 1,1-dimethyl ethyl hydroperxoide and octane), about 1.5-2.5% Norbloc 7966 (2-(2′hydroxy-5′methacryloxyethylphenyl)-2H-benzotriazole), about 4-8% Tinuvin 99 (3(2H-Benzotriazole-2-yl) 5-(1,1-dimethyl ethyl) -4-hydroxybenzenepropanoic acid, C7-9-branched alkyl esters), about 1-3% Tinuvin 171 (2(2H-Benzotrizaol-2-yl)-6-(dodecyl)-4-methylphenol, branched and linear) about 0.5% CAB53 1-1 (Cellulose Acetate Butyrate), about 0.6-1.0% HS 40 (additive), about 1.0-3% D-62 (defoamer), about 0.25-1.0% D-604 (surfactant), about 1-4% Rad 2250, about 0.3-1.0% 1-500 ( 1-hydroxyacryciohexyl pentyl ketone), about 0.5-2% I-184 (1-hydroxy cyclohexyl pentyl ketone), about 0.5-2% D-1173 (oxy-2-methyl-1-phenyl-1 propanone), about 1-5% I-1700 ( bis(2,6-dimethoxybenzoyl)-2,4-,4-trimethylpentyl phosphine oxide), about 0.8-3% CN384 (acrylated amine acrylic ester), and about 0.25-1% FC 171 (flurochemcial surfactant).

10. An ultraviolet (UV) blocking ink comprising An ultraviolet (UV) blocking ink comprising about 30-45% SR399 (Dipentaerythritol pentaacrylate), about 6-10% CN104 (Epoxy acrylate), about 5-15% Eb5129 (urethane diacrylate), about 10-20% SR238 (urethane diacrylate), about 0.5-2% Tinuvin 123 (decanedioic acid, bis (2,2,6,6,-tetra methyl -4-piperidinyl) ester reaction products with 1,1-dimethyl ethyl hydroperxoide and octane), about 2.5-5% Norbloc 7966 (2-(2′hydroxy-5′methacryloxyethylphenyl)-2H-benzotriazole), about 4-10% Tinuvin 99 (3(2H-Benzotriazole-2-yl) 5-(1,1-dimethyl ethyl) -4-hydroxybenzenepropanoic acid, C7-9-branched alkyl esters), about 1-3% Tinuvin 171 (2(2H-Benzotrizaol-2-yl)-6-(dodecyl)-4-methylphenol, branched and linear) about 0.5-2% CAB531-1 (Cellulose Acetate Butyrate), about 0.6-1.0% HS 40 (additive), about 1.0-3% D-62 (defoamer), about 0.25-1.0% D-604 (surfactant), about 0.3-1.0% 1-500 ( 1-hydroxyacryciohexyl pentyl ketone), about 0.5-2% I-184 (1-hydroxy cyclohexyl pentyl ketone), about 0.5-3% D-1 173 (oxy-2-methyl-1-phenyl-1 propanone), about 1-5% I-1700 ( bis(2,6-dimethoxybenzoyl)-2,4-,4-trimethylpentyl phosphine oxide), about 0.8-3% CN384 (acrylated amine acrylic ester), and about 0.25-1% FC1 71 (flurochemcial surfactant).

11. A UV blocking transparent substrate comprising a transparent substrate coated with a UV blocking ink comprising the composition of claim 1.

12. The UV blocking transparent substrate of claim 11 further comprising a layer of at least one silane between the substrate and the UV blocking coating.

13. The UV blocking transparent substrate of claim 11 wherein the UV blocking coating is about 3 to 25 microns thick.

14. The UV blocking transparent substrate of claim 11 wherein the UV blocking coating is about 15 microns thick.

15. The UV blocking transparent substrate of claim 11 which absorbs more than about at least 90% of UV light transmission between about 300 to 400 nanometers.

16. The UV blocking transparent substrate of claim 11 which absorbs more than about at least 97% of UV light transmission between about 300 to 385 nanometers.

17. The UV blocking transparent substrate of claim 11 wherein the substrate is glass.

18. A UV blocking transparent substrate produced by the process comprising:
coating a transparent substrate with the UV blocking ink of claim 1 to a thickness of about 3 to 25 microns; and
curing the composition with UV light transmitted at about 325 to about 415 nanometers.

19. The UV blocking transparent substrate of claim 18 wherein the process further includes applying a layer of silane prior to applying the coating of UV blocking ink.

20. The UV blocking transparent substrate of claim 18 wherein the UV blocking ink is a thickness of about 15 microns.

21. The UV blocking transparent substrate of claim 18 wherein the UV blocking ink is cured at about 395 to about 415 nanometers.

22. A UV blocking transparent substrate produced by the process comprising:
coating a transparent substrate with the UV blocking ink of claim 9 to a thickness of about 3 to 25 microns; and
curing the composition with UV light transmitted at about 325 to about 415 nanometers.

23. A UV blocking transparent substrate produced by the process comprising:
coating a transparent substrate with the UV blocking ink of claim 10 to a thickness of about 3 to 25 microns; and
curing the composition with UV light transmitted at about 325 to about 415 nanometers.
